(19) United States
(12) Patent Application Publication
(10) Pub. No.: US 2025/0010659 A1
(43) Pub. Date: Jan. 9, 2025

(54) NUT SLEEVE

(71) Applicants: Alex Doan, Garden Grove, CA (US); Eric Chang, Yorba Linda, CA (US)

(72) Inventor: Vivi Lee, Garden Grove, CA (US)

(21) Appl. No.: 18/762,251

(22) Filed: Jul. 2, 2024

Related U.S. Application Data
(60) Provisional application No. 63/617,208, filed on Jan. 3, 2024.

(30) Foreign Application Priority Data
Jul. 7, 2023 (CN) 202321773370.X

(51) Int. Cl. B60B 29/00; B25B 23/00

(52) U.S. Cl. CPC B60B 29/00; B25B 23/0035

(57) ABSTRACT

A socket includes a head part 1 and a body 2, characterized in that an inside of a first socket hole 21 of the body 2 is provided with an inner plastic sleeve 3 attached to an inner wall thereof in a replaceable way, wherein, the head part 1 can dock with an internal angle head nut or a bolt to drive its rotation. The inner plastic sleeve 3 mats with a nut or bolt and drive its rotations. The inner plastic sleeve 3, as provided inside the body 2, not only can it increase the friction in contact with the nut or bolt, which increases the efficiency of the socket operation, the user can also replace the inner plastic sleeve 3 when the inner plastic sleeve 3 is damaged or slips after multiple uses. As the user only need to replace the inner plastic sleeve 3 instead of replacing the entire metal socket, the present invention significantly reduces the operation costs, saves social resources, and avoid unnecessary waste.

### TECHNICAL FIELD

The present disclosure relates to a disassembly and assembly tool technical field, and more particularly to a nut sleeve.

### BACKGROUND

A socket is a tool used to tighten or loosen nuts and bolts. It is usually made of metal and has a hollow cylindrical structure with a cross-section inside that adapts to nuts of different types and sizes. Common cross-sections include: hexagonal, triangular, pentagonal, etc. The socket is used in conjunction with a wrench or spanner handle to provide leverage so that sufficient force can be applied to tighten or loosen the nut. This tool is often used in mechanical repair, automotive maintenance and construction to effectively complete the removal and installation of nuts and bolts.

Since the traditional socket is made entirely of metal, it will wear out after prolonged usage, and the inner wall of the socket will lose its precision of the original shape, which it becomes easy to slip when works on the nuts or bolts, resulting in the inability to tighten or loosen the nuts or bolts. Over time, the socket is in a scrap state, and the entire socket is usually replaced, resulting in a huge waste of resources and a significant increase in costs. For example, Chinese Patent No. CN2132595Y, titled “multi-faceted sleeve head for sleeve wrenches, and Chinese Patent No. CN 2633519Y, titled “Mult-functional sleeve head”, these existing sockets as disclosed are all made of metal material as a whole, and all have the above-mentioned technical insufficiency.

In view of this, the inventor proposes the following technical solution.

### SUMMARY

The object of the present disclosure is to overcome the insufficiency of existing technologies, and provide an improved socket.

In order to solve the above technical problems, the present disclosure adopts the following technical solutions: a socket, comprising: a head part and a body, characterized in that an inside of a first socket hole of said body is provided with an inner plastic sleeve attached to an inner wall thereof in a replaceable way, where, said head part can dock with an internal angle head nut or bolt head and drive its rotation, and said inner plastic sleeve can dock with an outer angle head nut or bolt head and drive its rotation.

Furthermore, in the above technical solution, a cross section of said first socket hole is a hexagon, pentagon, or triangle, a shape of said inner plastic sleeve is consistent with said shape of said cross section of said first nut sleeve hole, and attached to an inner wall of said first nut sleeve hole.

Furthermore, in the above technical solution, an inside of said first socket hole is provided with an inner step adapted to position said inner plastic sleeve, and one end of said inner plastic sleeve is provided with an inner extension edge for pressing against and positioned by said inner step.

Furthermore, in the above technical solution, where said inner step contacts with said inner extension edge is provided with an inclined transition surface for easy pulling.

Furthermore, in the above technical solution, said inner plastic sleeve and an inner wall of said first socket hole are bonded by any adhesive selected from structural glue, AB glue, and quick-drying glue.

Furthermore, in the above technical solution, an edge line intersection of a cross section of said first socket hole is provided with an inverted inner circular corner recessed toward said inner wall, and an intersection of every two adjacent surfaces of said outer wall of said inner plastic sleeve is also provided with an inverted outer circular corner correspondingly to said inverted inner circular corner.

Furthermore, in the above technical solution, said head part is provided with a second socket hole adapted to dock and match with a nut or bolt head, and a cross section of said second nut sleeve hole is a hexagon, pentagon, or triangle.

Furthermore, in the above technical solution, an outer wall of said head part is at least provided with a section of hexagon head adapted to dock and match with a nut or bolt head, and an extended-through communication hole is provided between said first socket hole and said second socket hole.

Furthermore, in the above technical solution, an outer wall of said socket body is further sleeved with an outer plastic sleeve capable of being disassembled, assembled and replaced, and said outer wall of said sleeve part is provided with an outer step adapted to position said outer plastic sleeve.

Furthermore, in the above technical solution, said inner plastic sleeve and said outer plastic sleeve are made of Polyoxymethylene (POM).

The present disclosure has the following advantages comparted to the existing technologies: in the invention as disclosed in the present disclosure provides the inner plastic sleeve to mat and contact with the nut or bolt head. The inner plastic sleeve increases the friction force in contact with the nut or bolt head, it also conveniently increases the torque applied on the nut or bolt. After multiple uses, when the inner plastic sleeve is damaged or slips, user can replace the inner plastic sleeve needs instead of abandoning the entire metal socket, which can significantly reduce the cost of use, save social resources, and avoid unnecessary waste.

### BRIEF DESCRIPTION OF THE DRAWINGS

FIG. 1 is a perspective view of the present disclosure.

FIG. 2 shows an inner structure of the present disclosure.

FIG. 3 is a perspective view of a head part and a socket body part of the present disclosure.

FIG. 4 is a perspective view of an inner plastic sleeve of the present disclosure.

### DETAILED DESCRIPTION

The present disclosure is further described below in conjunction with specific embodiments and accompanying drawings. In particular, the nut sleeve is for working on the car wheels.

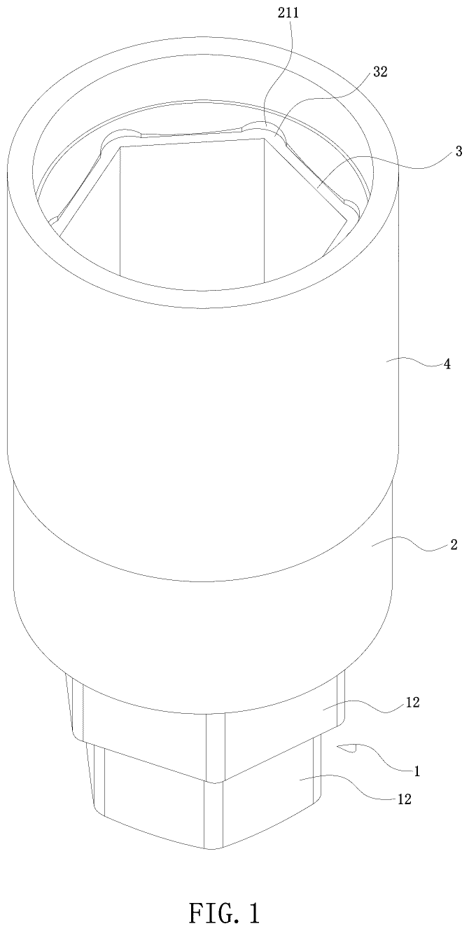

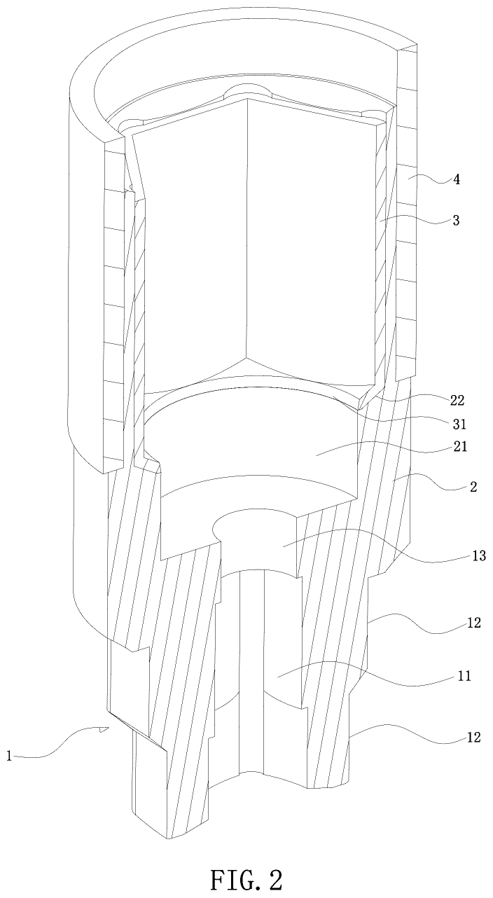

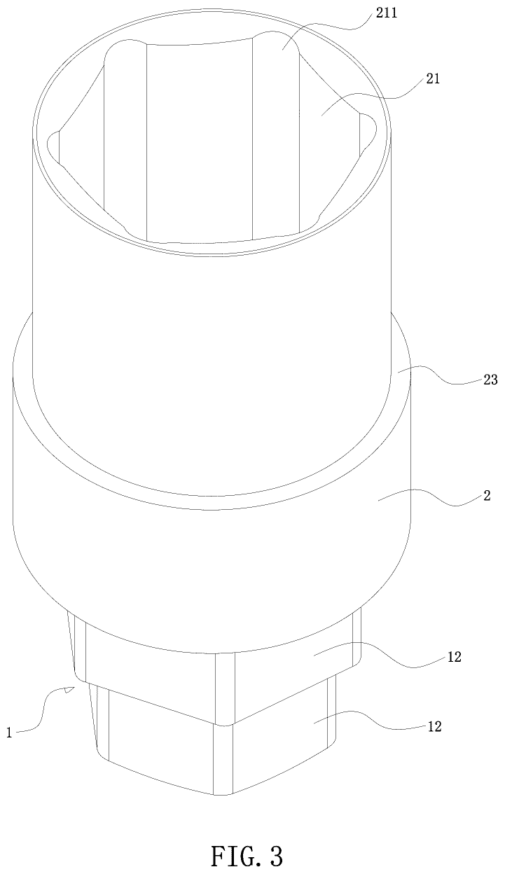

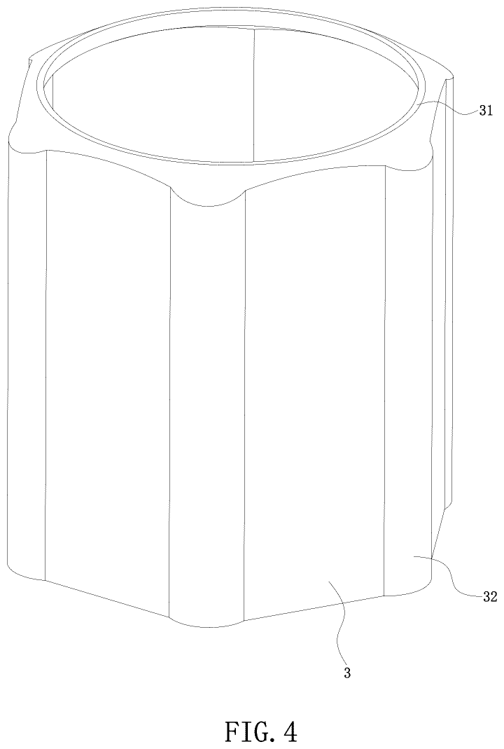

Referring to FIGS. 1 to 4, the socket of the present disclosure includes a head 1 and a body 2, and the inside of a first socket hole 21 of the body 2 is equipped with an inner plastic sleeve 3 attached to the inner wall thereof. The inner plastic sleeve 3 can be easily removed away from the body 2 and replaced.

The head part 1 is capable of docking with an angle wrench or spanner handle which drive the head part's rotation. The inner plastic sleeve 3, as positioned within the first socket hole 21, is configured to mat with a nut of bolt and drives its rotation. The inner plastic sleeve 3, as provided inside the body 2, not only can it increase the friction in contact with the nut or bolt, which increases the efficiency of the socket operation, the user can also replace the inner plastic sleeve 3 when the inner plastic sleeve 3 is damaged or slips after multiple uses. As the user only need to replace the inner plastic sleeve 3 instead of replacing the entire metal socket, the present invention significantly reduces the operation costs, saves social resources, and avoid unnecessary waste.

The cross section of the first socket hole 21 is any one of hexagon, pentagon, and triangle, and the shape of the inner plastic sleeve 3 is consistent with the shape of the cross section of the first socket hole 21 and attached to the inner wall of the first socket hole 21. The inside of the first socket hole 21 is provided with an inner step 22 adapted to position the inner plastic sleeve 3, and one end of the inner plastic sleeve 3 is provided with an inner extension edge 31 for pressing against and being positioned by the inner step 22. The contact of the inner step 22 with the inner extension edge 31 provides an inclined transition surface for easy pulling. The inner plastic sleeve 3 and the inner wall of the first socket hole 21 are bonded by any adhesive selected from structural glue, ab glue, and quick-drying glue.

The intersection of every two adjacent edge lines of the cross section of the first socket hole 21 is provided with an inverted inner circular corner 211, which is recessed toward the inner wall. The intersection of every two adjacent surfaces of the outer wall of the inner plastic sleeve 3 is provided with an inverted outer circular corner 32 corresponding to the inverted inner circular corner 211. The first socket hole 21 and the inner plastic sleeve 3 are respectively provided with the inverted inner circular corners 211 and the inverted outer circular corners 32. The inverted outer circular corners 32 is employed to prevent any breakage on the inner plastic sleeve 3 caused by the stress concentration at the corners between any two adjacent side surfaces of the inner plastic sleeve 3. Such that it increases the usable life of the inner plastic sleeve 3, and the inverted inner circular corner 211 further allows the inner plastic sleeve 3 and the first socket hole 21 to be attached more tightly, so as to ensure that there is no relative sliding between the inner plastic sleeve 3 and the body 2 during operations.

The head part 1 is provided with a second socket hole 11 for docking and matching with the nut or bolt head, where the cross section of the second socket hole 11 is a hexagon, pentagon or triangle, and the second socket hole 11 is smaller than the first socket hole 21. As the inside of the head part 1 is provided with the second nut sleeve hole 11, it allows the head part 1 also performs a docking operation with a polygonal nut or bolt, such as a hexagonal nut or bolt, which it provides a socket with two connecting ends, thereby improving the scope of use and increasing versatility.

The outer wall of the head part 1 is at least provided with a section of hexagonal head 12 used to dock and match with a nut or bolt head. An extended-through communication path 13 is provided between the first socket hole 21 and the second socket hole 11. The head part 1 is provided with two sections of hexagonal heads 12 of different sizes. The head part 1 is provided the two sections of hexagonal heads 12 of different sizes, so that the socket can be used with inner angle nuts of different sizes, and the hexagonal head 12 of the head part 1 can enable the nut sleeves of different sizes to be stacked on top of each other for easy storage.

The outer wall of the socket body 2 is further sleeved with an outer plastic sleeve 4 capable of being disassembled, assembled and replaced. The socket body 2 is also provided with an outer step 23 adapted to position the outer plastic sleeve 4. The inner plastic sleeve 3 and the outer plastic sleeve 4 are made of POM. The outer plastic sleeve 4 is sleeved on the body 2, the outer plastic sleeve 4 can increase friction, it provides convenience for manually twisting the socket when auxiliary tools cannot be used in a small space, thereby increasing the applicable range of the socket.

In summary, when operate the socket as disclosed in the present disclosure, the socket body 2 is matted with the wheel bolt head of the automobile, allowing the inner plastic sleeve 3 to be touched the bolt head. The wrench or spanner handle is used to dock the head 1. Since the head 1 has both a hexagonal head 12 and a second socket hole 11, an inner hexagonal wrench or an outer hexagonal wrench can be used to connect with the head 1 and to rotate the socket for removing or installing the bolts. The use of the inner plastic sleeve 3 to contact the bolt head will increase the friction of the contact, avoid slipping, and generate greater torque on the bolt. The inner plastic sleeve 3 also can be replaced in time when it is broken due to stress. There is no need to replace the entire socket, such it increases the service life of the socket, reduces usage costs, and saves social resources.

Of course, the above are only specific embodiments of the present disclosure and are not intended to limit the implementation scope of the present disclosure. Any equivalent changes or modifications made in accordance with the structure, features and principles described in the claims of the present disclosure should be included in the claims of the present disclosure.

What is claimed is:

1. A socket, comprising:
a head part;
a body with a first socket hole; and
an inner sleeve positioned within said first socket hole;
wherein said inner sleeve is detachable from said first socket hole;
wherein said head part is configured to dock with an internal angle head nut or bolt to rotate said internal angle head nut or bolt; and
wherein said inner sleeve is configured to dock with an outer angle head nut or bolt head to rotate said outer angle head nut or bolt.

2. The socket according to claim 1, wherein said first socket hole and said inner sleeve have an identical shape of a hexagon, a pentagon, or a triangle.

3. The socket according to claim 1, wherein said body further includes an inner step within said first socket hole fore positioning said inner sleeve, and said inner sleeve has an inner extension edge pressing against said inner step.

4. The socket according to claim 3, wherein said inner step has an inclined transition surface pressing against said inner extension edge for easy pulling.

5. The socket according to claim 1, wherein said inner sleeve is attached within said first socket hole by an adhesive selected from structural glue, AB glue, and quick-drying glue.

6. The socket according to claim 1, wherein each corner of said first socket hole is an inverted inner circular corner, and each corner of said inner sleeve is an inverted outer circular corner corresponding to each said inverted inner circular corner of said first socket hole.

7. The socket according to claim 1, wherein said head part has a second socket hole configured to dock and match with a nut or bolt head, and said second socket hole is a hexagon, a pentagon, or a triangle.

8. The socket according to claim 7, furthering comprising:
an extended-through communication path between said first socket hole and said second socket hole.

9. The socket according to claim 1, wherein said head part has an outer shape configured to dock and match with an internal angel head nut or bolt, and said outer shape is a hexagon, a pentagon, or a triangle.

10. The socket according to claim 9, wherein said head part further comprises a first section with a first size and a second section with a second size, said first section is configured for an internal angel head nut or bolt with said first size, and said second section is configure for an internal angel head nut or bolt with said second size.

11. The socket according to claim 10, wherein said second section is smaller than said first section, and said socket is stackable.

12. The socket according to claim 10, wherein said first section is smaller than said body, and said socket is stackable.

13. The socket according to claim 1, further comprising:
an outer sleeve sleeved over said body, wherein said outer sleeve is detachable from said body.

14. The socket according to claim 13, wherein said body further includes an outer step for positioning said outer sleeve.

15. The socket according to claim 14, wherein said inner sleeve and said outer sleeve are made of Polyoxymethylene (POM).
